(19) United States
(12) Patent Application Publication
(10) Pub. No.: US 2002/0088670 A1
(43) Pub. Date: Jul. 11, 2002

(54) Quick release oil pan adapter system

(76) Inventor: Ronald Kraig Rice, Oklahoma City, OK (US)

Correspondence Address: RONALD K. RICE, 1300 BROADVIEW DR., OAKLAHOMA CITY, OK, 73127, US

(21) Appl. No.: 10/024,254

(22) Filed: Dec. 21, 2001

Related U.S. Application Data
(60) Provisional application No. 60/256,577, filed on Dec. 20, 2000.

(51) Int. Cl. F16N 31/00

(52) U.S. Cl. 184/106

(57) ABSTRACT

The receiver rail is the key part of the invention and is new to any fastener design in Drag Racing oil pans. It holds the oil pan firmly in place on the left side of the adapter rail. The oil pan is easily slid into the receiver rail at a slight angle. When it is pushed against the inside edge of the receiver rail the pan is raised up into place and seals completely against the o-rings around the pan flange. The four ¼ turn fasteners are snapped into place on the right side and installation is complete. This eliminates the need for any bolts.

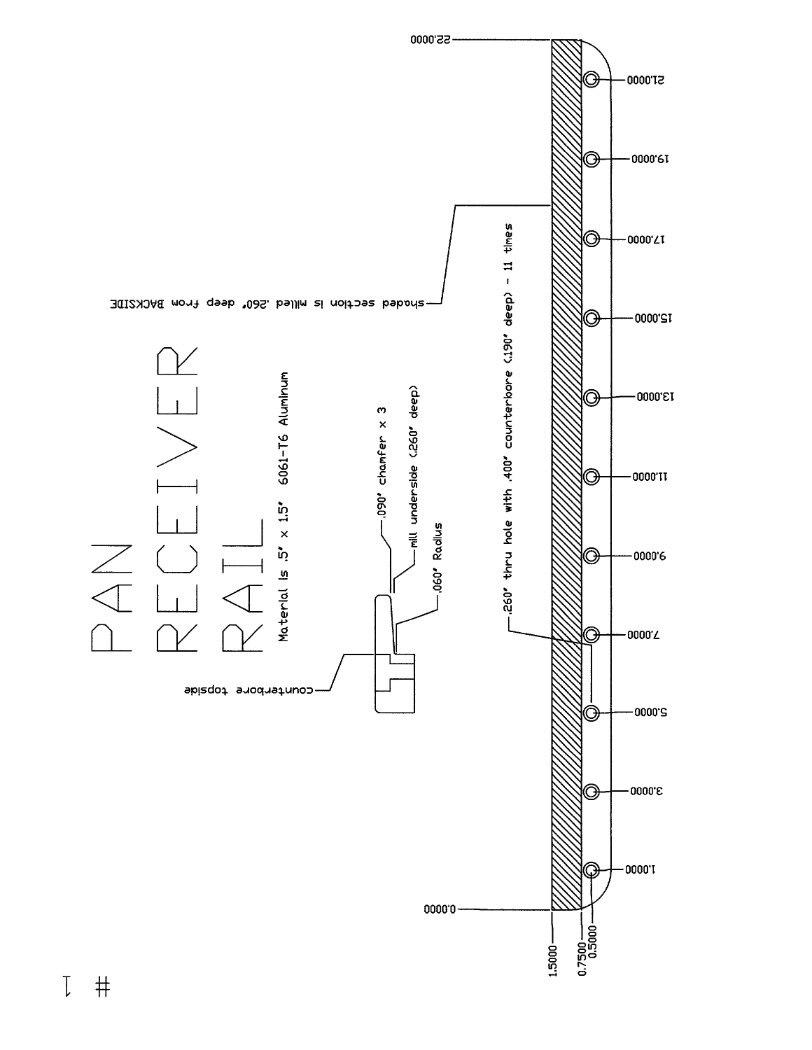

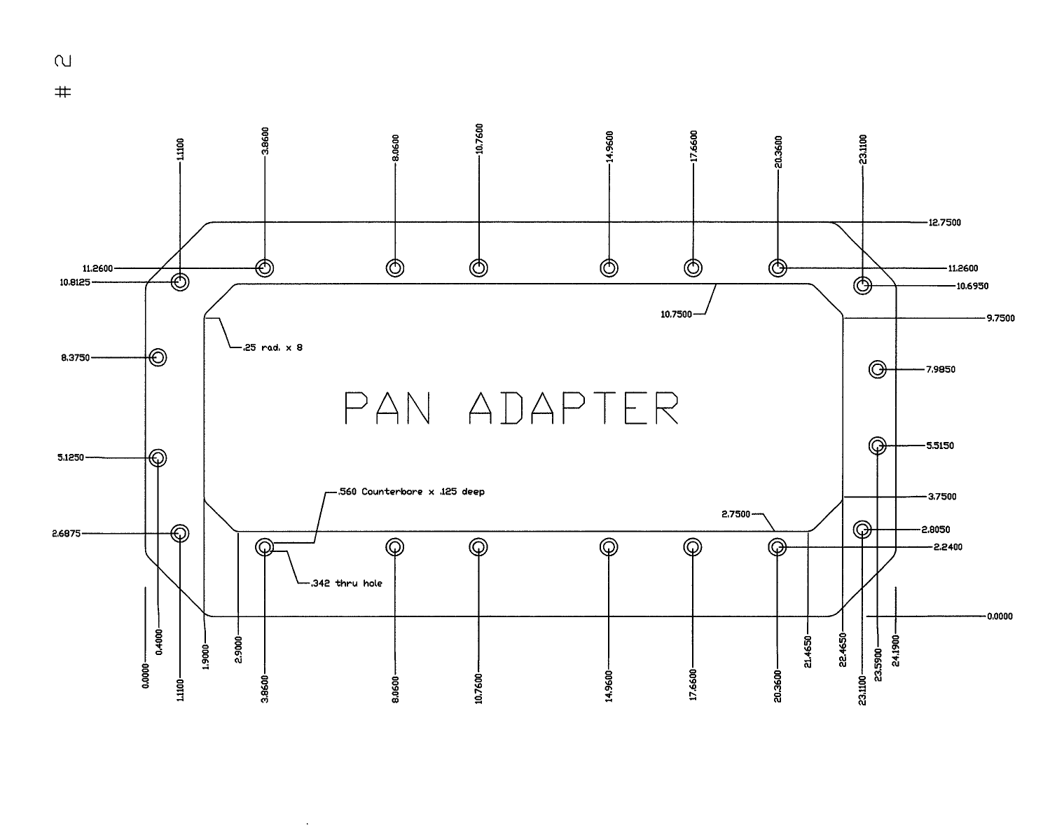

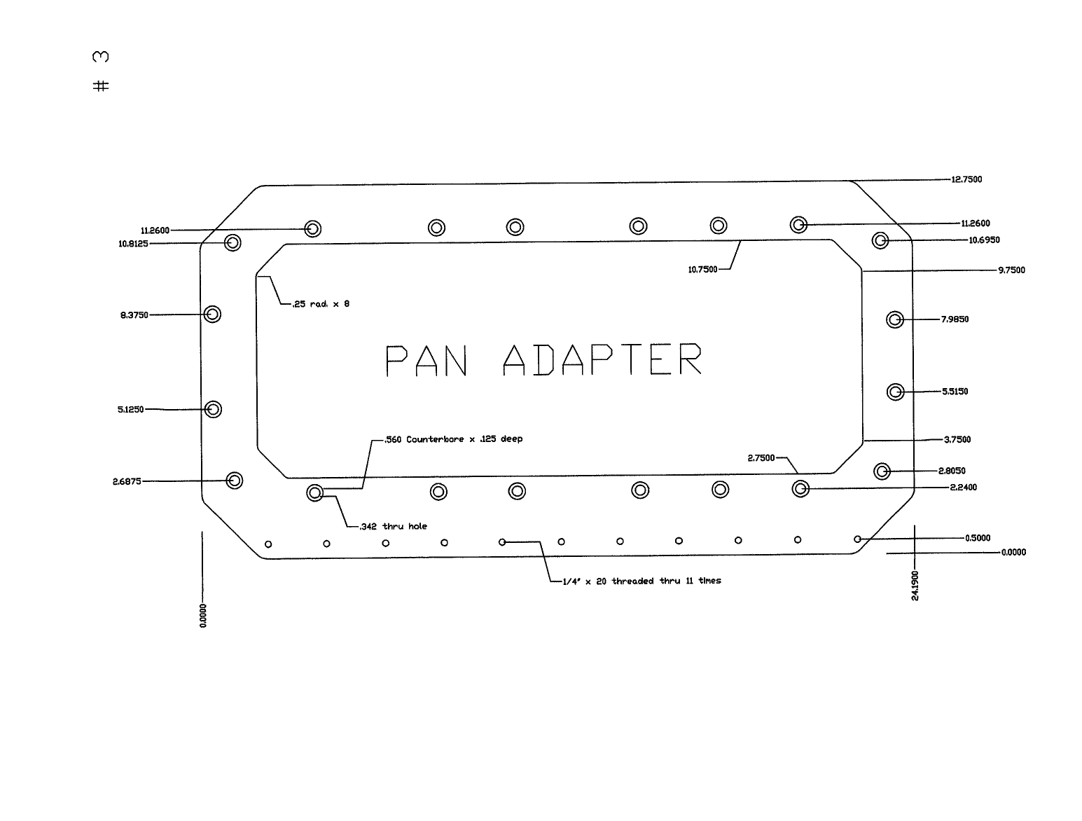

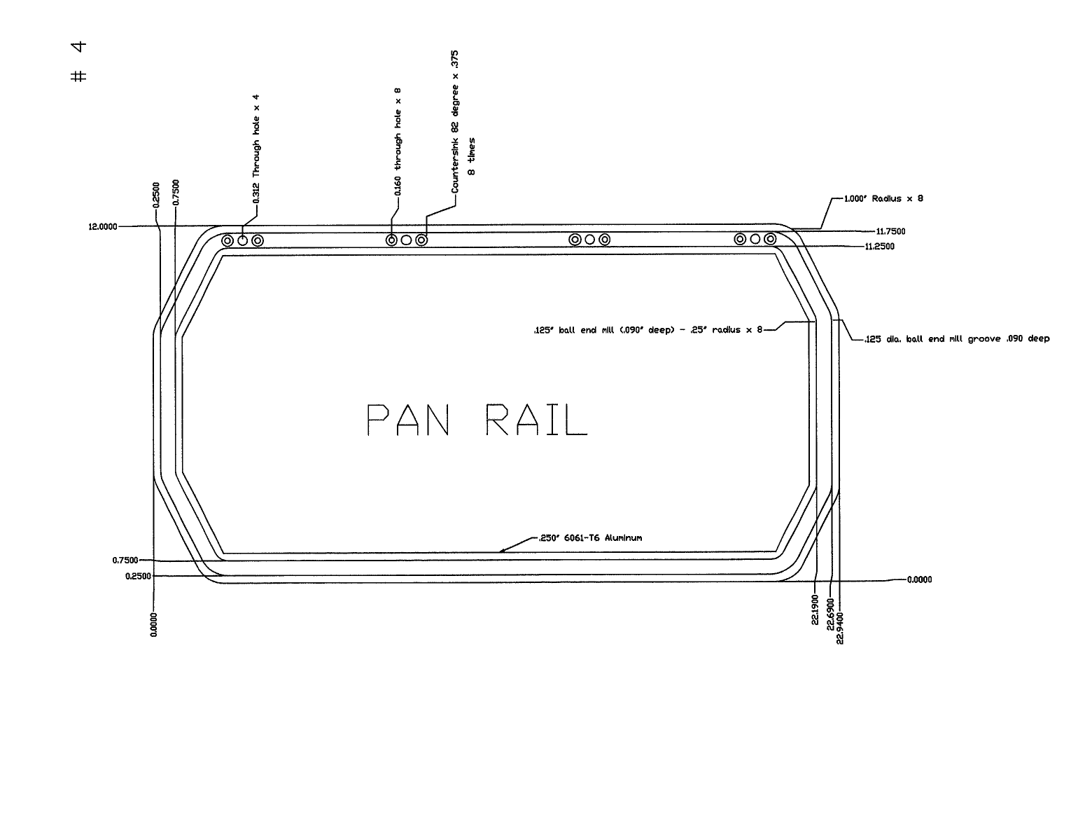

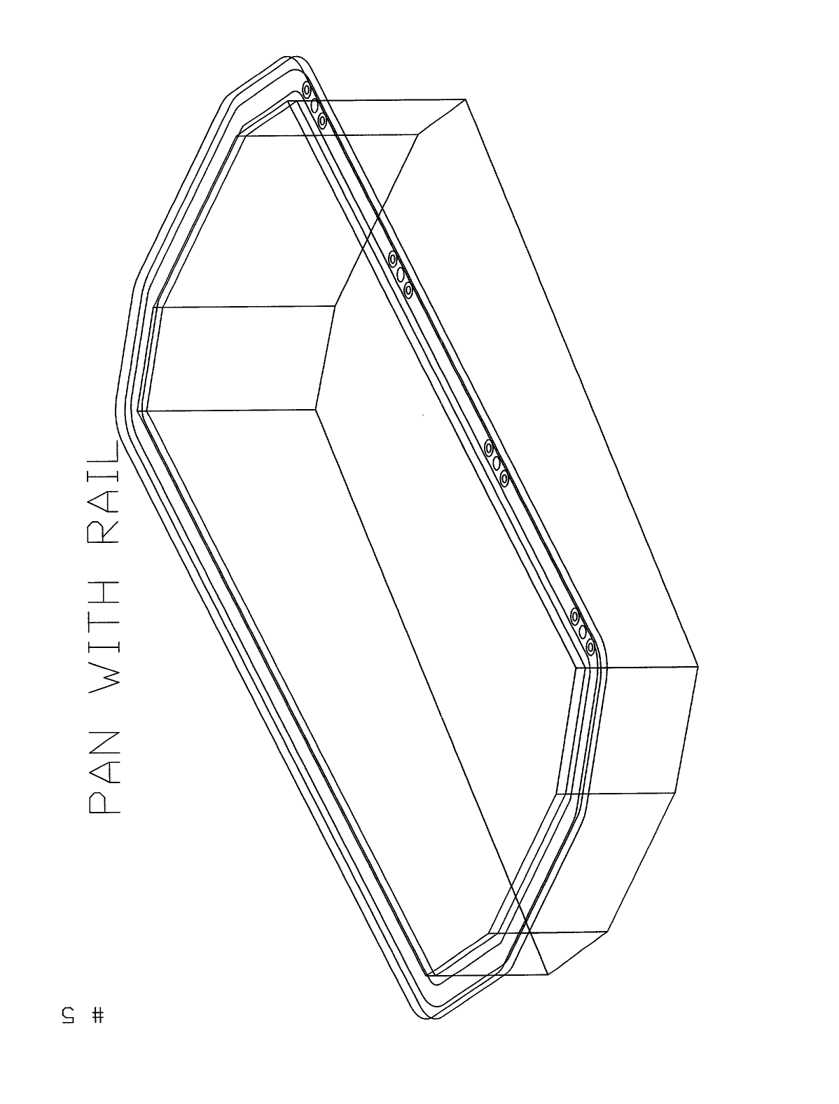

### BACKGROUND

The invention pertains to the automotive racing industry, more specific in relation to racing engine oil pans, and the difficulty and time taken to remove and reinstall them.

### SUMMARY

In many forms of racing, engine maintenance must be performed during the duration of the race. In drag racing certain classes of racecars such as Top Fuel dragsters have only 70 minutes to service engines between runs. This can include a complete tear down of the engine including pistons, rods, bearings and other related parts. This requires the oil to be drained and the oil pan to be removed to enable access to these parts. A normal oil pan can have 20 or more bolts holding the pan on the engine block. With sealed gaskets it can take 5 to 10 minutes to remove. After cleaning and scraping the old gasket off, sealer is used on the new gasket and the pan is reinstalled on the block using the 20 or more bolts (if they can be found). This can take an additional 10 minutes. With the quick release oil pan adapter system the time is cut to seconds.

### DETAILED DESCRIPTION OF THE INVENTION

The quick release oil pan adaptor and receiver rail system are constructed entirely of aluminum. The receiver rail is 0.5″×1.5″×21.5″ and made of 6061 T-6 aluminum. It is milled with a notch ¾″ deep to accept the rail of the oil pan and is bolted to the adapter plate using 11¼″×20 alen head bolts on the left side with the pan facing forward on the car.

The adaptor plate, which accepts the receiver rail, is constructed of 6061 T-6 aluminum 0.250″ thick. The outside measures 12¾″×20½″. The inside opening measures 8″×20½″. It is drilled and countersunk with 22 5/16″ holes to bolt to the block in the factory bolt pattern. The left side extends past the factory width to accept the 11 tapped ¼″×20 holes that are used to fasten the notched receiver rail.

The oil pan flange is 6061 T-6 aluminum 0.250″ thick. The flange is 1″ wide and measures 12″×23″ outside and 11″×22″ inside. Two o-ring grooves are milled 0.125″ diameter and 0.090″ deep, completely around the pan rail ⅜″ apart. Four 5/16″ holes are drilled on the right side to allow the ¼ turn fasteners to pass thru. The spring retainers are bolted to the underside of the pan rail centered on these 4 holes.

The sump of the oil pan is constructed of 0.090″ 5052-H32 aluminum. The size varies as to the depth for different applications and engine blocks. The right side has a 1″ drain and drain plug with o-ring seal.

1. I claim the receiver rail contained on the adapter plate will allow the oil pan containing the double o-ring rail to be removed and reinstalled in seconds compared to existing drag racing oil pans which take 10 minutes or more to remove alone.
